(19) United States
(12) Patent Application Publication
(10) Pub. No.: US 2012/0294029 A1
(43) Pub. Date: Nov. 22, 2012

(54) BACKLIGHT AND DISPLAY DEVICE WITH THE BACKLIGHT

(75) Inventors: Yanbing WU, Beijing (CN); Wei WEI, Beijing (CN); Weitao CHEN, Beijing (CN)

(73) Assignee: BOE Technology Group Co., Ltd., Beijing (CN)

(21) Appl. No.: 13/474,134

(22) Filed: May 17, 2012

(30) Foreign Application Priority Data
May 19, 2011 (CN) 201120161839.5

(51) Int. Cl. F21V 8/00; G09F 13/04

(52) U.S. Cl. 362/602; 362/97.1; 362/613

(57) ABSTRACT

Embodiments of the present disclosure provide a backlight and display device with the backlight which may enhance the light efficiency and enable energy saving and be easily implemented. The backlight comprises a light source module generating a light with nonuniform light intensity distribution; and an optical module located above the light source module. In the backlight and display device of the embodiment of the present disclosure, the light intensity of the fields of view on the left and right sides can be enhanced, the light intensity of central region can be lowered, thus matching the light intensity distribution of the backlight to the distribution of the field of view of a binocular stereo vision product, increasing light efficiency and reducing the brightness of cross talking region.

### BACKGROUND

The present disclosure relates to a backlight and a display device with the backlight.

Parallax barrier method is a well known technique in the field of binocular stereo vision. As shown in FIG. 1, a slit grating 2 disposed above a display unit 1 is an optical device composed of periodically alternating light transmissive stripes and light blocking stripes. The basic principle of the parallax barrier method is as following. An observer on the left of the display unit 1 can only see one part of pixels on the display unit 1 (pixels indicated by dotted regions in FIG. 1) through the light transmissive stripes of the slit grating 2 and an observer on the right of the display unit 1 can only see the other part of pixels (pixels indicated by blank regions in FIG. 1) on the display unit 1 through the light transmissive stripes of the slit grating 2. In this way, the effect of binocular stereo vision may be achieved by applying different image signals to the pixels in the black regions and dotted regions, respectively. However, for a typical backlight with a uniform light intensity distribution in the display unit 1, the brightness of central cross-talking region in the display unit 1 is very high during binocular stereo display, which leads to low light efficiency of the backlight.

### SUMMARY

Embodiments of the present disclosure provide a backlight and display device with the backlight which may enhance the light efficiency and enable energy saving and be easily implemented.

In one aspect, embodiments of the present disclosure provide a backlight comprising a light source module generating a light with nonuniform light intensity distribution; and an optical module located above the light source module.

In the embodiments, the light source module comprises a light guiding plate and at least two light source units located on both sides of the light guiding plate, respectively, the light guiding plate has a lower surface which has at least one groove. The lower surface of the light guiding plate has at least two grooves and the light guiding plate portion between the adjacent two grooves has an indented shape, or the light guiding plate portion between the adjacent two grooves has a triangular cross sectional shape in a direction perpendicular to the groove.

In the embodiments, the light source unit comprises at least two light sources arranged in a direction parallel to the groove. The groove is located in a central region of the lower surface the light guiding plate.

In the embodiments, the light source module comprises at least one light source submount which has a side surface; and at least one light source unit attached on the side surface of the light source submount. The light source submount has a wedge shape. The side surface of light source submount is a concave mirror surface such that the lights from the light source unit facing the concave surface become parallel lights after being reflected by the concave surface.

In another aspect, embodiments of the present disclosure provide a display device comprising a display unit, a slit grating disposed above the display unit and a backlight disposed below the display unit. The backlight comprises a light source module generating a light with nonuniform light intensity distribution; and an optical module located above the light source module.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from the following detailed description.

### BRIEF DESCRIPTION OF THE DRAWINGS

The present disclosure will become more fully understood from the detailed description given hereinafter and the accompanying drawings which are given by way of illustration only, and thus are not limitative of the present disclosure and wherein:

FIG. 1 is a schematic view showing principle of a binocular stereo vision;

FIG. 2 is a structural schematic view of a backlight according to an embodiment of the present disclosure;

FIG. 3 is a structural schematic view of a backlight according to another embodiment of the present disclosure;

FIG. 4a-FIG. 4d are cross sectional schematic views of grooves according to an embodiment of the present disclosure;

FIG. 5 is a structural schematic view of a backlight according to another embodiment of the present disclosure;

FIG. 6 is a schematic view of the principle of a backlight of the present disclosure;

FIG. 7a-FIG. 7d are schematic views of positional relation between a light source unit and groove in an embodiment of the present disclosure;

FIG. 8 is a structure schematic view of backlight according to another embodiment of the present disclosure;

FIG. 9 is a structure schematic view of a light source submount according to an embodiment of the present disclosure;

FIG. 10 is a structure schematic view of a light source submount according to another embodiment of the present disclosure; and

FIG. 11 is a structure schematic view of a display device according to another embodiment of the present disclosure.

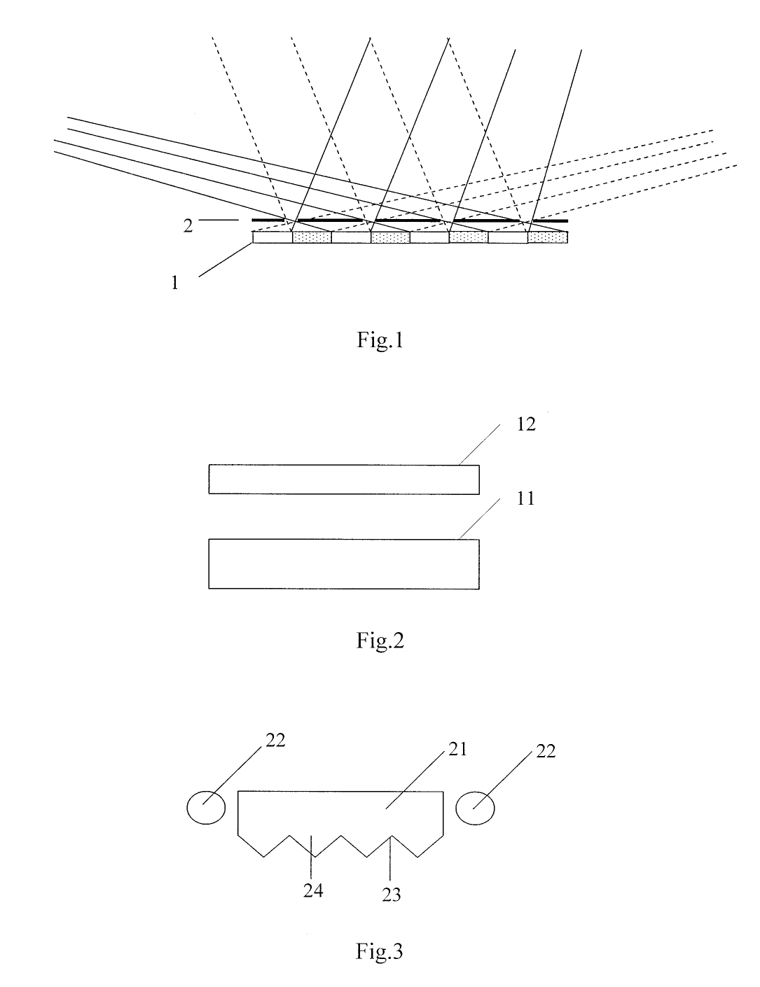

### DETAILED DESCRIPTION

The embodiments of the present disclosure will be described further in detail in conjunction with the drawings.

As shown in FIG. 2, a backlight according to one embodiment of the present disclosure may include a light source module 11 for generating a light with a non-uniform light intensity distribution and an optical module 12 located above the light source module 11.

The optical module 12 may comprise an optical film. The optical module 12 may be selected and configured based on the light source module 11 as desired.

As shown in FIG. 3, the light source module 11 may include a light guiding plate 21 and at least two light source units 22 located on both side of the light guiding plate 21 respectively.

The light guiding plate 21 has at least a groove 23 on its lower surface. Preferably, the lower surface of the light guiding plate 21 has at least two grooves 23 such that a light guiding plate portion 24 between adjacent grooves 23 has indented shape. Further, the lower surface of the light guiding plate 21 may have at least two parallel grooves 23, the number of which may be set as desired. Moreover, the groove 23 may be located in a central region of the lower surface of the light guiding plate 21.

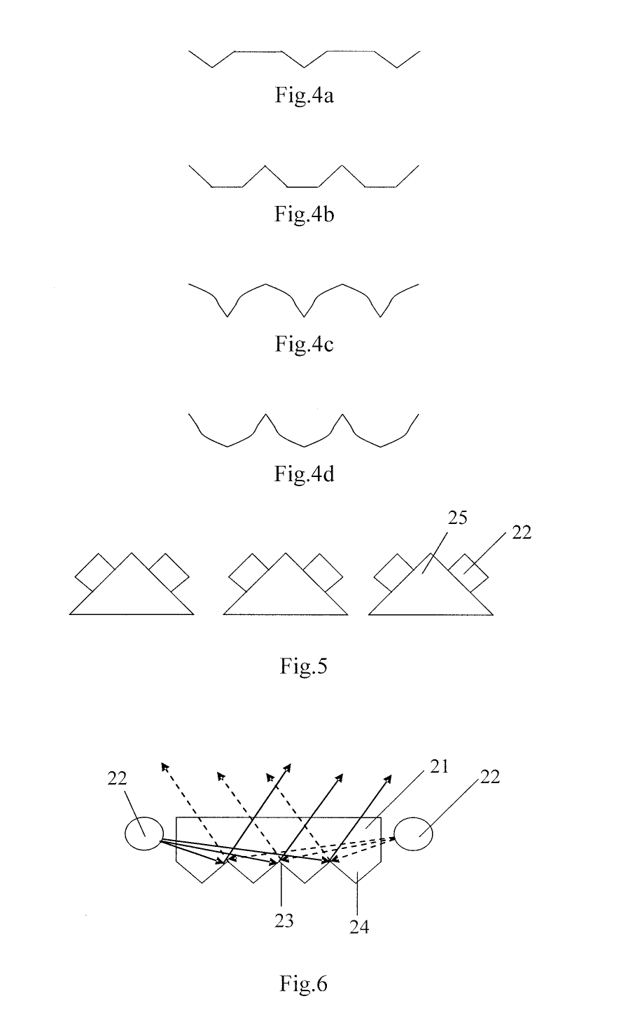

Preferably, the lower surface of the light guiding plate 21 has at least two grooves 23, and the light guiding plate portion 24 between two adjacent grooves 23 has a triangular cross sectional shape in a direction perpendicular to the groove 23. The triangular shape may be any triangles with arbitrary internal angles, for example a regular triangle or right-angled triangle. The cross sectional shape of the light guiding plate portion 24 is not limited to triangles but can have other shapes such as those shown in FIG. 4a-FIG. 4d, as long as it can reflect the light from the light source units in two directions.

Preferably, the light source unit 22 may include at least two light sources arranged along a direction parallel to the groove 23.

In the above embodiment, the lower surface of the light guiding plate is formed to have an indented shape and the light source units are disposed on the both sides of the light guiding plate, thus enabling the light from the light source on the left side of the light guiding plate is reflected towards the right side of the light guiding plate and the light from the light source on the right side of the light guiding plate is reflected towards the left side of the light guiding plate. Accordingly, it can enhance the light intensity in peripheral regions on the left and right sides of the backlight and lower the light intensity in the central region of the backlight, thus improving light efficiency in the binocular stereo display and reducing the brightness of the central cross talking region.

As shown in FIG. 5, a light source module according to another embodiment of the present disclosure may comprise at least one light source submount 25 each having a side surface and at least one light source unit 22 attached on the side surface of the light source submount 25.

Preferably, each light source submount 25 is a wedge-shaped submount or a submount with other shapes which has a side surface with the light source unit attached thereon.

Preferably, the side surface of the light source submount 25 is concave mirror surface such that parallel light rays can be reflected from such concave surface when the light source unit 22 emits light towards the concave submount, which further facilitates redistributing the light intensity towards the peripheral regions of the backlight.

In the backlight according to the embodiment of the present disclosure, the light source unit is attached on the side surface of the light source submount, thus enabling the light generated by the light source unit deflecting towards the left side and/or right side of the backlight.

The light source unit 22 as described above can include a point light source or a line light source. Moreover, each light source unit 22 includes at least one light source. Preferably, the light source can be a LED (Light Emitting Diode) and/or a CCFL (Cold Cathode Fluorescent Lamp), for example. That is to say, the light source unit 22 may be composed of a single kind of light sources or a combination of multiple kinds of light sources.

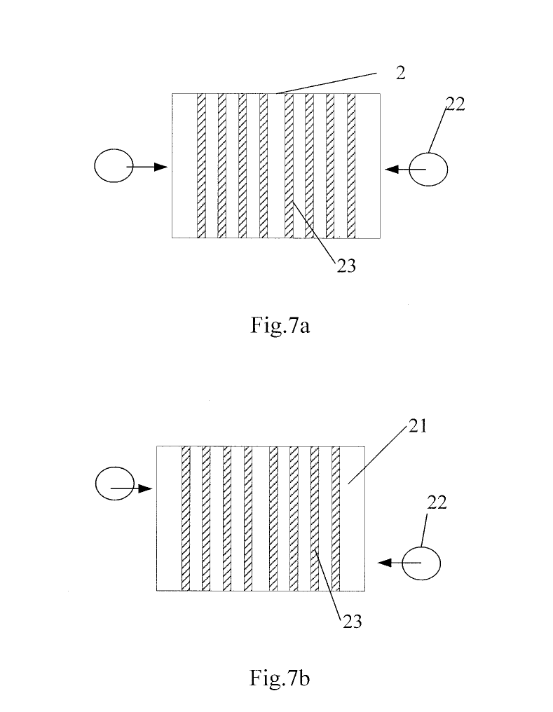

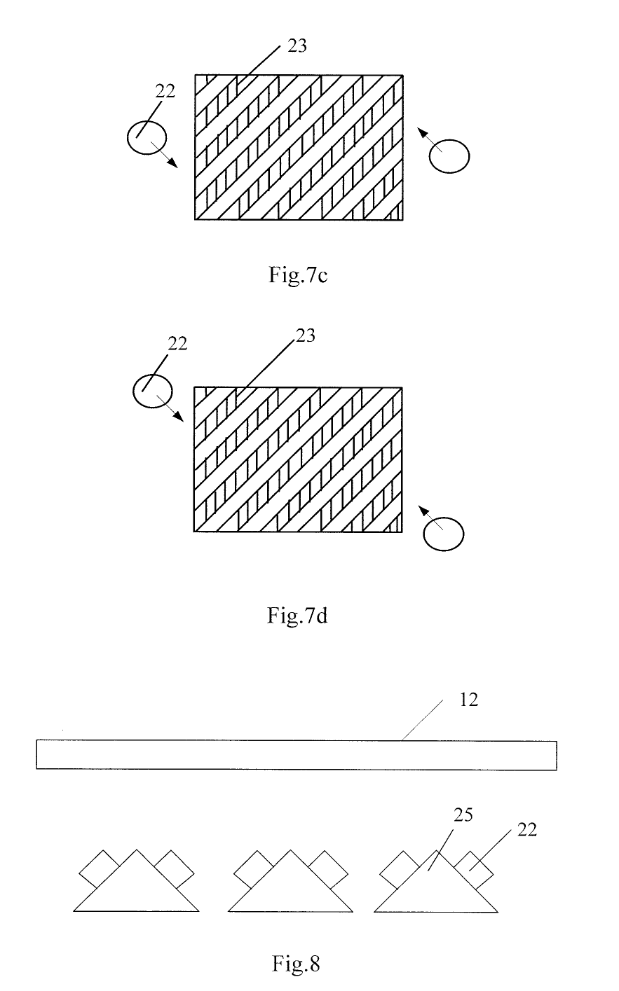

The backlight according to the present disclosure will be described in detail through specified embodiments as following. As shown in FIG. 6, the lower surface of light guiding plate 21 has a plurality of parallel grooves 23 with indented light guide plate portion 24 therebetween. A light source unit 22 is disposed on each side of the light guiding plate 21. The light source unit can include LEDs disposed along the extension direction of the groove 23. When the grooves 23 are parallel to the edge of the light guiding plate 21, light source units 22 may be disposed opposing each other as shown in FIG. 7a, or may be disposed offset relative to each other as shown in FIG. 7b. When the grooves 23 is inclined relative to the edge of the light guiding plate 21, light source units 22 may be disposed opposing each other as shown in FIG. 7c, or may be disposed offset relative to each other as shown in FIG. 7d.

In the above embodiment, the light ray emitted by the light source unit 22 (indicated as the straight arrow line) is reflected by the side surface of the groove 23 towards the opposite direction relative to the respective light source unit 22. Preferably, the light emitted by the light source unit 22 has a direction perpendicular to the extension direction of the groove 23.

As shown in FIG. 6, the light emitted by the light source unit 22 on the left side of the light guiding plate 21 is reflected by the groove 23 towards upper right direction with respect to the light guiding plate 21 (indicated by solid arrow lines). The light emitted by the light source unit 22 on the right side of the light guiding plate 21 is reflected by the groove 23 towards upper left direction with respect to the light guiding plate 21 (indicated by dotted arrow lines).

In the backlight according to the present embodiment of the present disclosure, the lower surface of light guiding plate is formed to have an indented shape and the light source units are disposed on both sides of the light guiding plate, such that the light emitted by the light source on the left side of the light guiding plate is reflected towards the right side of the light guiding plate and the light emitted by the light source on the right side of the light guiding plate is reflected towards the left side of the light guiding plate. Accordingly, the light intensity of the fields of view on the left and right sides can be enhanced, the light intensity of central region can be lowered, thus matching the light intensity distribution of the backlight to the distribution of the field of view of a binocular stereo vision product, increasing light efficiency and reducing the brightness of cross talking region.

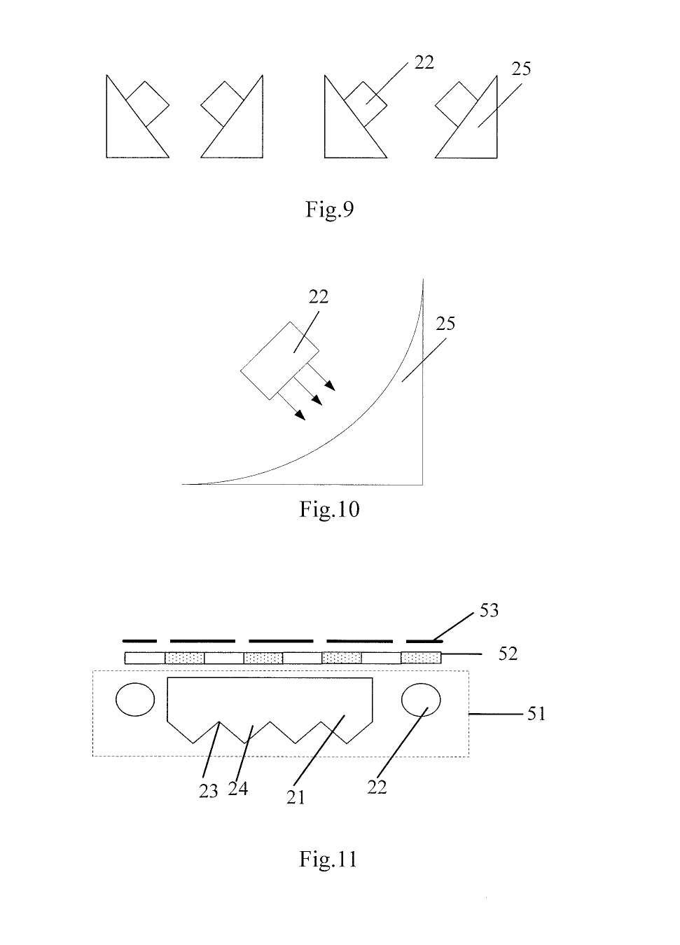

As shown in FIG. 8, a light source unit 22 is attached on each side surface of a plurality of light source submounts 25 which can have a cross sectional shape selected from a wedge, a trapezoid or a triangle. An optical module 12 is disposed above the plurality of light source submounts 25. Further, as shown in FIG. 9, the light source submount 25 may have only one side surface with the light source unit 22 attached thereon. If each light source submount 25 has only one side surface with the light source unit 22 attached thereon, it is necessary to arrange the side surfaces of the submounts in the backlight module to have substantially different orientations; alternatively, the light source submount 25 having only one side surface with the light source unit 22 attached thereon can be combined with the light source submount 25 having a plurality of side surfaces with the light source units 22 attached thereon in the backlight module.

Preferably, as shown in FIG. 10, when the side surface of the light source submount 25 is a concave mirror surface, the light source unit 22 is disposed with its emitting surface facing the side surface of the light source submount 25. In this way, the light emitted by the light source unit 22 become parallel light rays after being reflected by the concave mirror, which facilitates redistributing the light intensity towards the left and right side.

The lights from the plurality of light source units are emitted towards the left and right side respectively, such that the light intensity distribution received by the optical module 12 is nonuniform with relatively strong light intensity in the peripheral regions on left and right sides and relatively weak light intensity in the central region.

Accordingly, the embodiment of the present disclosure provides a display device. As shown in FIG. 11, the display device comprises a display unit 52, a slit grating 53 and a backlight 51 as described above.

In the backlight and display device according to the embodiment of the present disclosure, the lower surface of light guiding plate is formed to have an indented shape and the light source units are disposed on both sides of the light guiding plate, such that the light emitted by the light source on the left side of the light guiding plate is reflected towards the right side of the light guiding plate and the light emitted by the light source on the right side of the light guiding plate is reflected towards the left side of the light guiding plate. Accordingly, the light intensity of the fields of view on the left and right sides can be enhanced, the light intensity of central region can be lowered, thus matching the light intensity distribution of the backlight to the distribution of the field of view of a binocular stereo vision product, increasing light efficiency and reducing the brightness of cross talking region.

The embodiment of the present disclosure being thus described, it will be obvious that the same may be varied in many ways. Such variations are not to be regarded as a departure from the spirit and scope of the present disclosure, and all such modifications as would be obvious to those skilled in the art are intended to be included within the scope of the following claims.

What is claimed is:

1. A backlight comprising
a light source module generating a light with nonuniform light intensity distribution; and
an optical module located above the light source module.

2. The backlight according to claim 1,
wherein the light source module comprises a light guiding plate and at least two light source units located on both sides of the light guiding plate, respectively,
wherein the light guiding plate has a lower surface which has at least one groove.

3. The backlight according to claim 2, wherein the lower surface of the light guiding plate has at least two grooves and the light guiding plate portion between the adjacent two grooves has an indented shape.

4. The backlight according to claim 2, wherein the lower surface of the light guiding plate has at least two grooves and the light guiding plate portion between the adjacent two grooves has a triangular cross sectional shape in a direction perpendicular to the groove.

5. The backlight according to claim 2, wherein the light source unit comprises at least two light sources arranged in a direction parallel to the groove.

6. The backlight according to claim 2, wherein the groove is located in a central region of the lower surface the light guiding plate.

7. The backlight according to claim 1, wherein the light source module comprises
at least one light source submount which has a side surface;
at least one light source unit attached on the side surface of the light source submount.

8. The backlight according to claim 7, wherein the light source submount has a wedge shape.

9. The backlight according to claim 7, wherein the side surface of light source submount is a concave mirror surface such that the lights from the light source unit facing the concave surface become parallel lights after being reflected by the concave surface.

10. A display device comprising a display unit, a slit grating disposed above the display unit and a backlight disposed below the display unit, the backlight comprising a light source module generating a light with nonuniform light intensity distribution; and an optical module located above the light source module.

11. The display device according to claim 10,
wherein the light source module comprises a light guiding plate and at least two light source units located on both sides of the light guiding plate, respectively,
wherein the light guiding plate has a lower surface which has at least one groove.

12. The display device according to claim 11, wherein the lower surface of the light guiding plate has at least two grooves and the light guiding plate portion between the adjacent two grooves has an indented shape.

13. The display device according to claim 11, wherein the lower surface of the light guiding plate has at least two grooves and the light guiding plate portion between the adjacent two grooves has a triangular cross sectional shape in a direction perpendicular to the groove.

14. The display device according to claim 11, wherein the light source unit comprises at least two light sources arranged in a direction parallel to the groove.

15. The display device according to claim 11, wherein the groove is located in a central region of the lower surface the light guiding plate.

16. The display device according to claim 10, wherein the light source module comprises
at least one light source submount which has a side surface;
at least one light source unit attached on the side surface of the light source submount.

17. The display device according to claim 16, wherein the light source submount has a wedge shape.

18. The display device according to claim 16, wherein the side surface of light source submount is a concave mirror surface such that the lights from the light source unit facing the concave surface become parallel lights after being reflected by the concave surface.
